(19) United States
(12) Patent Application Publication
(10) Pub. No.: US 2001/0003351 A1
(43) Pub. Date: Jun. 14, 2001

(54) DRY PARTICULATE DISPERSON SYSTEM AND FLOW CONTROL DEVICE THEREFOR

(76) Inventors: PATRICK P. CHEN, APPLETON, WI (US); CHARLES D. NUCCI, SEWELL, NJ (US)

Correspondence Address: BRINKS HOFER GILSON & LIONE, P O BOX 10395, CHICAGO, IL, 60610

(21) Appl. No.: 09/222,624

(22) Filed: Dec. 29, 1998

Related U.S. Application Data
(60) Provisional application No. 60/070,012, filed on Dec. 30, 1997.

(51) Int. Cl. B05B 7/24

(52) U.S. Cl. 239/124; 239/143; 239/310

(57) ABSTRACT

A dry particulate dispersion system includes a fluidized bed of particulate material, an intake device within the fluidized bed, and a controllable source of supplemental gas connected to the intake device. The amount of supplemental gas supplied to the intake device controls the amount of suspended particulate material withdrawn through the intake device. The intake device may be coupled to a venturi eductor, which then sucks the supplemental gas and fluidized particulate material out of the fluidized bed and entrains it in a stream of pressurized gas flowing to a dispersion apparatus, such as a spray nozzle.

### RELATED APPLICATION

The present application claims priority under 35 U.S.C. §119(e) to Provisional U.S. patent application Ser. No. 60/070,012 filed on Dec. 30, 1997, which is hereby incorporated by reference.

### BACKGROUND OF THE INVENTION

The present invention is directed to a dry particulate dispersion system, and particularly to a method and apparatus for controlling the flow of dry particulate material within such a system.

In many instances it is desired to create a dispersion of dry particulate material. On example is spraying a material in dry powder form onto a substrate. A common system for creating such a dispersion is to entrain the dry particulate material in a stream of pressurized air flowing to a spray nozzle. When the spray nozzle is activated, the particulate material is discharged in a dispersion to cover the substrate.

A common way of entraining the dry particulate or powder material in the flowing stream of pressurized gas is to first suspend the particulate material in a fluidized bed. A venturi eductor is connected to the fluidized bed by a suction hose. High pressure air is forced through an orifice in the eductor, which creates a vacuum and draws suspended particulate material from the fluidized bed into the suction hose. The particulate material is then entrained in the stream of air exiting the orifice and directed to the spray nozzle.

One problem that has been encountered in such dry particulate dispersion systems has been to control the rate of particulate material addition to the flowing stream of pressurized air and thus being applied to dispersion to match changing rates of movement of the web. Since the suction created by the venturi is proportional to the pressure drop across the orifice, one way to decrease the rate at which the particulate material is being withdrawn is to reduce the pressure of the air stream supplied to the venturi. However, if the pressure of the air supplied to the orifice is reduced, the flow rate of the air is inherently reduced as well. Such pressure and flow rate reductions are often undesirable.

Also, prior art dispersion systems have not been able to supply relatively low rates of particulate material application, nor provide precise flow rates, particularly at low powder flow rates. This is due in part to the fact that the amount of material drawn in by the venturi eductor is dependent on the flow of pressurized air through the orifice. If the flow rate is dropped to reduce the amount of particulate material being drawn into the stream of pressurized air, the air velocity in the hose supplying the spray nozzle may not be sufficient to cause turbulent flow and keep the particulate material suspended and flowing. The diameter of the hose can be reduced, but such a change over is complicated and could not be done “on the fly,” but rather would require shutting down the system. Moreover, hoses come in standard sizes, and choosing a hose to match small changes in flow rate may not be possible. The orifice size could be changed to create less suction, but again this could not be accomplished quickly with conventional equipment. Plus, a change of the orifice size would require adjusting the supply pressure to maintain a constant flow rate.

When only a small flow rate of particulate material is needed, one could supply an excess amount of powder and then remove the excess from the substrate. This however entails a loss of powder, or the need for greater capacity in a powder recovery system, with attendant higher operating and capital costs, not to mention potential detriment to the environment or workplace safety.

Another problem with conventional systems is that when the type or other properties of the powder change, the fluidized bed will have different amounts of suspended particles per unit volume, resulting in the amount of powder being withdrawn for the same air flow rate and orifice size being different. It would be advantageous to be able to control the rate of the dry powder flow to easily accommodate changes in the particulate material in the fluidized bed.

One suggested modification to conventional powder dispersion equipment is disclosed in U.S. Pat. No. 4,586,854 to Newman et al., incorporated herein by reference. In the disclosed apparatus, a diffuser is located in the flow path from the fluidized bed to the venturi orifice. In addition to the main air flow through the orifice, another conduit is used to supply air to the chamber containing the diffuser. It is noted that the greater the air pressure supplied by this conduit to the diffuser chamber, the less the flow rate of powder drawn into the venturi, and the less flow rate of powder in the main air stream. One drawback to this system is that the diffuser creates very turbulent flow, which results in possible erratic behavior of the powder flow rate. Also, if too much air is supplied to the conduit going into the diffuser, the suction of the venturi will not be sufficient to withdraw this air and still keep a sufficient flow of suspended particles out of the fluidized bed. At low flow rates out of the suction hose, the flow of powder material may be sporadic. Also, the disclosed apparatus would not be suitable if the specific gravity of the particulate material were too great. The apparatus is not believed to be very precise. Further, a change to a different powder in the fluidized bed would require changes in the system.

Thus there is a need for a dry particulate dispersion system that can precisely control the amount of particulate material being supplied and easily adjust the rate of addition of the particulate material to the main flowing stream of pressurized air, particularly to supply low flow rates of particulate material.

### SUMMARY OF INVENTION

A dry particulate dispersion system and flow control method and apparatus therefore which solves the foregoing problems has been invented.

In a first aspect, the invention is a dry particulate dispersion system comprising a fluidized bed of particulate material; an intake device inside the fluidized bed through which the particulate material may be withdrawn from the fluidized bed; and a controllable source of pressurized gas connected to and providing supplemental gas to the intake device, the amount of supplemental gas supplied to the intake device controlling the amount of particulate material withdrawn through the intake device.

In a second aspect, the invention is an apparatus for spraying a dry powder material onto a substrate comprising a fresh powder feeding system; a fluidized bed receiving fresh powder from the powder feeding system and creating a fluidized bed of suspended powder; an intake device in the fluidized bed; a suction hose connected to the intake device for withdrawing suspended powder entering the intake device from the fluidized bed; a source of supplemental air connected to the intake device and supplying a controllable flow of supplemental air to the intake device; a venturi eductor connected to the suction hose and to a supply of pressurized air, the eductor including an orifice such that pressurized air flowing through the orifice creates a venturi that sucks suspended powder through the suction tube and entrains it in the air exiting out of the orifice; and a spray nozzle connected to said venturi eductor, the spray nozzle being directed to spray said powdered material on said substrate.

In yet another aspect, the invention is a method of controlling the rate of particulate material addition to a flowing pressurized gas stream comprising the steps of: providing a fluidized bed of suspended particulate material; placing an intake device within the fluidized bed, the intake device having at least one particulate material intake port, an outlet port, and a supplemental gas supply inlet port; connecting the intake device outlet port to a conduit carrying the flowing pressurized gas stream; causing a pressure differential between the at least one particulate intake port and the outlet port so that suspended particulate material in the fluidized bed enters the at least one intake port and passes out the outlet port and into said conduit; and supplying supplemental gas to the intake device at a controlled rate, the controlled rate of supplemental gas affecting the rate of suspended particulate material entering the at least one particulate material inlet port and hence the rate of addition of the particulate material to the flowing pressurized gas stream.

By using a controllable source of supplemental air fed into the intake device within the fluidized bed, it is possible to easily and precisely control the rate at which particulate material is withdrawn from the fluidized bed through the intake device, suction hose and venturi, without having to change the pressure or flow rate of the air carrying the particulate material to the spray nozzle or other dispersion apparatus. Flow rates of particulate material may be quickly changed by changing the flow of supplemental air to the intake device. Also, low flow rates of particulate material can be achieved without sporadic results, and with precision.

These and other advantageous of the present invention will be best understood in view of the attached drawings, a brief description of which follows.

### BRIEF DESCRIPTION OF THE DRAWINGS

FIG. 1 is a schematic drawing of a dry particulate dispersion apparatus using the present invention.

FIG. 2 is a schematic drawing of the intake device and supplemental air supply used in the dry particulate dispersion apparatus of FIG. 1.

FIG. 3 is a perspective view of a preferred dry particulate intake device used in the apparatus of FIGS. 1 and 2.

FIG. 4 is an exploded view of the intake device of FIG. 3.

FIG. 5 is a cross-sectional view of the intake device of FIG. 3.

FIG. 6 is a cross-sectional view of a second embodiment of an intake device that could be used in the apparatus of FIGS. 1 and 2.

FIG. 7 is an elevational end view of the intake device of FIG. 6.

FIG. 8 is a cross-sectional view of a third embodiment of an intake device that could be used in the apparatus of FIGS. 1 and 2.

FIG. 9 is an elevational end view of the intake device of FIG. 8.

### DETAILED DESCRIPTION OF THE DRAWINGS AND PREFERRED EMBODIMENTS OF THE INVENTION

FIG. 1 shows a schematic drawing of a preferred dry particulate dispersion system utilizing the present invention. Many of the components of this system are conventional to other systems which spray dry powder on a substrate, and thus not described in detail herein. The major components include a fresh powder feeding system 12, which may be a hopper. Fresh powder is fed into a fluidized bed 14, described in more detail below. Suspended particulate material is withdrawn through a venturi eductor 16 and conveyed in a stream of pressurized air or other gas flowing in hose 18 to a spray nozzle 20 inside of enclosure 22. The dry particulate material is dispersed by the spray nozzle 20 onto a substrate, such as a moving web of material (not shown) inside the enclosure 22. An excess powder recovery system is connected to the enclosure 22 to recycle any excess particulate material. As shown, the excess powder recovery system preferably includes a filter house 24 containing filters 26. Excess powder recovered from the filters can be added back to the fluidized bed, as shown. Filtered air is discharged into the atmosphere.

The fluidized bed 14 has a conventional perforated plate 32 and a source of fluidizing air. Fluidizing air enters the bottom of the fluidized bed 14 and passes upwardly through the perforated plate 32. Particulate material 34 above the perforated plate is fluidized in the upwardly moving air. A conventional vent (not shown) is used to relieve excess pressure from the fluidized bed 14.

In the present invention a particulate material intake device 40 through which particulate material may be withdrawn from the fluidized bed 14 is positioned in the fluidized bed 14. The fluidized bed 14 is also modified from conventional fluidized beds in that a hose 38 for supplemental air enters the fluidized bed and is connected to the intake device 40.

The venturi eductor 16 can be of a conventional design, and is not shown in detail, but it contains an orifice and is connected to a supply of high pressure air 42. A suction hose 44 connects the intake device 40 to the venturi eductor 16. Air under high pressure flows through the orifice in the eductor, creating a lower pressure in suction hose 44 than in the fluidized bed 14. As a result, particulate material is drawn into the intake device 40, passes through the suction hose 44 and becomes entrained in the air passing out of the orifice, creating a total air flow equal to the flow of the high pressure air and the flow of the air from suction hose 44. The particulate material and the stream of pressurized air pass out of the venturi eductor 16, through conveying hose 18 to spray nozzle 20, as described above.

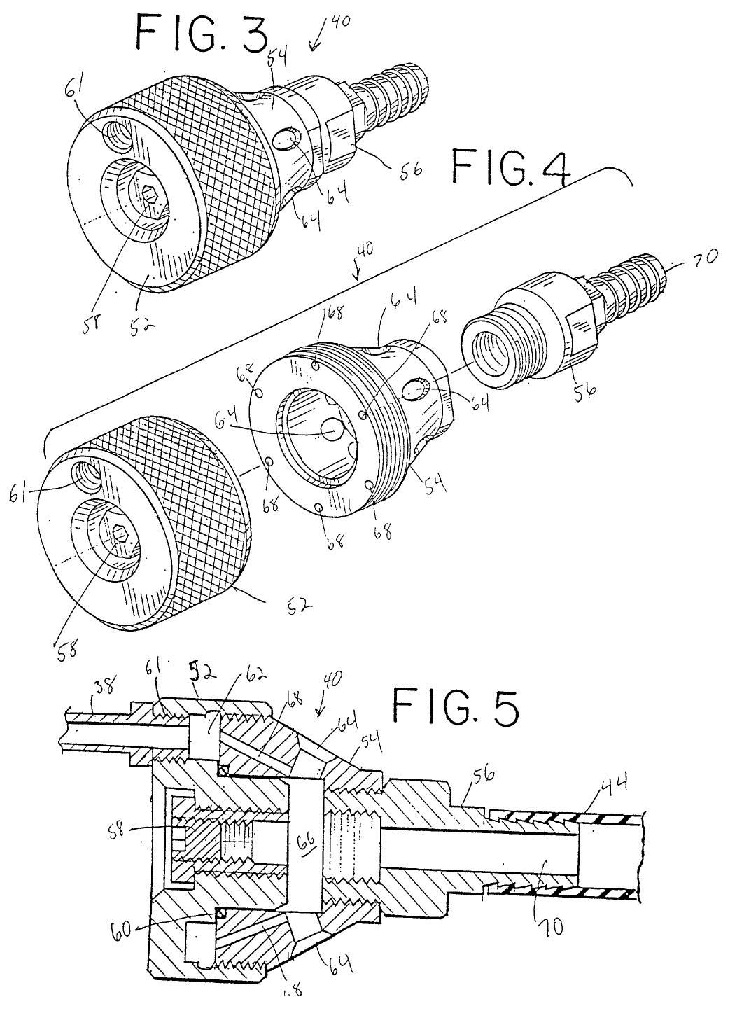

A preferred intake device 40 is shown in FIGS. 3-5. The intake device 40 is made of three basic pieces which are threaded and screwed together: A supplemental air inlet member 52, a mixing body 54 and an outlet member 56. The inlet member includes a threaded supplemental gas supply inlet port 61 to which hose 38 attaches. The threaded hole and plug 58 in the center of the inlet member 52 serve no function and could be solid with the rest of the inlet member 52. An o-ring 60 is used to seal between the inlet member 52 and mixing body 54. Also, an annular gap 62 is provided between the two parts. The inlet port 61 connects to this annular gap 62.

The mixing body 54 preferably includes a plurality of fluidized particle intake ports. The mixing body 54 has several holes drilled in it. Six large holes 64 through the side walls act as intake ports for the suspended particulate material. These open into central chamber 66. Six small holes 68 are drilled from the face of the mixing body 54. Each of these holes 68 connect with one of the intake ports 64. When the intake device 40 is assembled, these small holes 68 are in fluid communication with the annular gap 62. Thus supplemental air from hose 38 flows into the inlet port 61, through the annular gap 62 and up to the particulate material intake ports 64 through the supplemental air channels provided by holes 68. The supplemental air and particulate material suspended in air from the fluidized bed converge in central chamber 66 and flow out of the outlet port 70 formed in outlet member 56, to which suction hose 44 is attached.

The amount of supplemental air supplied to the intake device will control the amount of fluidized bed air and particulate material that enters the intake ports 64 and is thus withdrawn by the venturi eductor 16. As more supplemental air is supplied, the ratio of supplemental air to fluidized bed air in the air drawn out of the intake device 40 is increased. Therefore, even though the total rate of air flow in suction hose 44 can be constant, the rate of particulate material withdrawal will decrease with the reduced amount of air and suspended particulate material coming into intake ports 64 from the fluidized bed 14. On the other hand, if the rate of particulate material withdrawal needs to be increased, the supplemental air flow is decreased, which decreases the ratio of supplemental air to fluidized bed air, increasing the amount of air flowing into intake ports 64 carrying suspended particulate material.

Because the total flow of air through the suction hose 44 remains constant, the rest of the venturi eductor and spray system is unaffected. The total flow and the pressure of the air being supplied to the spray nozzle 20 can remain constant. Also, high air flow rates through the suction hose 44 and conveying hose 18 can be maintained even if only a small flow rate of particulate material enters the intake ports 64.

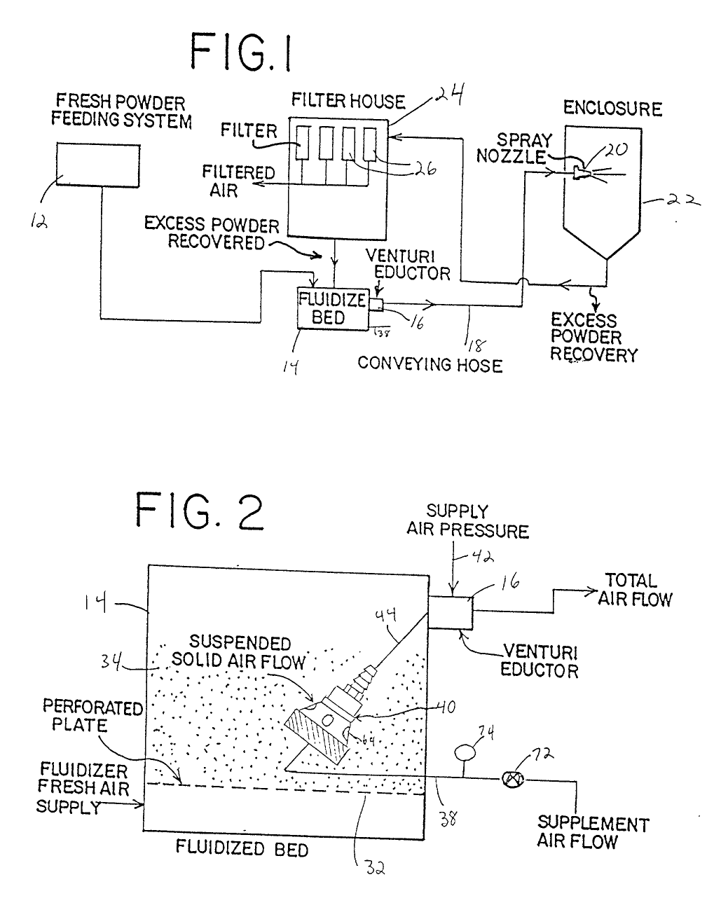

The flow of supplemental air is best controlled by a valve 72 (FIG. 2). A pressure gauge 74 downstream of the valve 72 allows an operator to monitor the pressure of the supplemental air in hose 38. This pressure will be proportional to the supplemental air flow rate, as the pressure in the fluidized bed is maintained fairly constant. Alternatively a volume flow control device could be used in place of the valve 72.

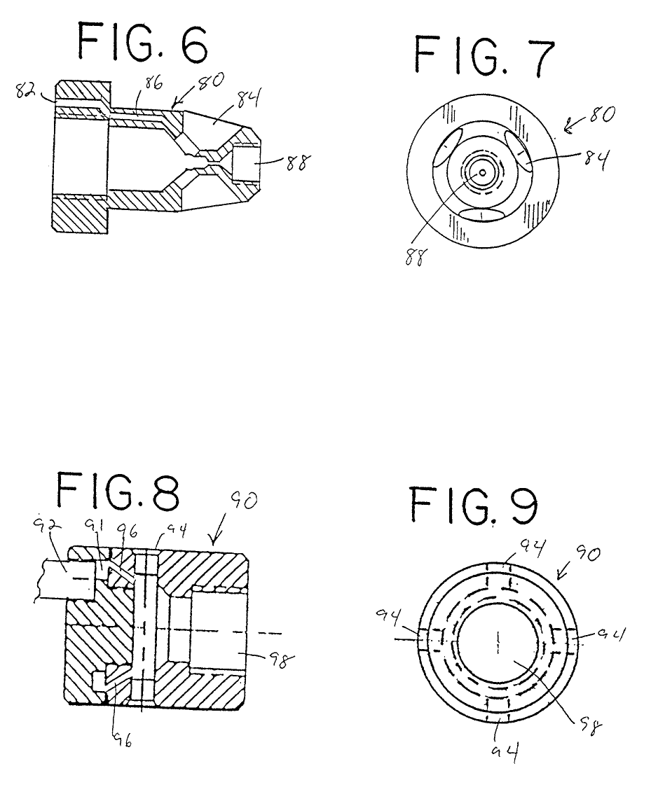

FIGS. 6 and 7 show a second embodiment of an intake device 80. The intake device 80 serves the same functions and has the same functional components as the intake device 40, namely a supplemental air inlet port 82, fluidized particulate intake ports 84, a supplemental air flow channel 86 and an outlet port 88.

FIGS. 8 and 9 show a third embodiment of an intake device 90. The intake device 90 likewise serves the same purpose as intake device 40 and has the same functional components, namely a supplemental air inlet port 92, fluidized particulate intake ports 94, supplemental air flow channels 96 connecting to a annular gap 91, and an outlet port 98.

While six intake ports 64 are shown in device 40, three intake ports 84 are shown for device 80, and four intake ports 94 are shown for device 90, only one, or a different plurality of intake ports could be used on each device. The intake ports can be any shape. The size of the intake ports can be such that the total open area of the intake ports is between 50% and 500% of the cross-sectional area of the suction hose 44. The supplemental air inlet port 61 can vary in size, and can be equal or smaller than that of the suction hose diameter.

In this embodiment, the venturi eductor 16 and conveying hose 18 together are considered a conduit for carrying a flowing pressurized gas stream to a dispersing device. In other embodiments, other structures could be used as a conduit. In the preferred embodiment, the venturi eductor causes a pressure differential between the particulate intake port 64 and the outlet port 70 which causes the suspended particulate material in the fluidized bed 14 to enter the intake ports 64 and pass out the outlet port 70 into the conduit. However other means of creating such a pressure differential are also contemplated by the present invention.

In addition to the fact that the present invention allows easy control of the powder output, without changing total air flow, orifice size, etc., the invention makes it possible to supply powder at lower rates and with less variation than prior art equipment. Whereas a typical output for a standard particulate spray system would be in the range of 500 to 2500 g/min., with a precision of about ±50 g/min. at the low flow rate, and about ±100 g/min. at high flow rates, with the present invention flow rates of 250 g/min., or even as low as 50 g/min., can be achieved, with a precision of ±10 g/min. at 500 g/min. of flow.

The intake device 40 is preferably made of metal, such as aluminum, but can be of any material as long as it has a sturdy shape and is compatible with the powders being used. Preferably the suction hose 44 will be flexible.

Using the present invention allows for a wide variety of particulate material to be applied. Particles with a size as small as about 5 or 10 microns as well as particles with a size of about 250-300 microns, and particles with sizes in between; and a particle specific gravity between 0.85 and 1.30 g/cm³, can easily be handled using the present invention. One example of a material handled by the present invention is baking soda, applied to a moving web of light weight tissue.

Using the present invention the powder output can be changed on the fly, such as when a substrate web speed changes. This eliminates downtime in the powder application process. Inventory costs can be reduced as there is no need for a large inventory of different parts, such as conveying hoses to handle different air flow rates.

With the low powder flow rates possible, overspray levels can be reduced, significantly reducing material waste and minimizing environment and workplace safety concerns. Also, expensive materials that might not otherwise be economical to apply can now be applied to a substrate using the present invention.

Product quality improvements may also result from the use of the present invention. Constant total air flow volume and constant air velocity to the spray nozzle 20 help assure a uniform powder application. The improved powder output precision enhances the product quality. Quick adjustments of powder flow rate meets changing operating conditions. Minimized powder overspray allows easier product quality control.

One other benefit possible with use of the present invention is that the venturi eductor 16 can be moved close to the spray nozzle 20. The supplemental air flow can help to keep the particulate material 34 withdrawn from the fluidized bed 14 suspended over a greater length of suction hose 44. As a result, the pressure drop between the venturi eductor 16 and the spray nozzle 20 will be minimized and a more uniform spray pattern can be achieved.

It should be appreciated that the apparatus and methods of the present invention are capable of being incorporated in the form of a variety of embodiments, only a few of which have been illustrated and described above. The invention may be embodied in other forms without departing from its spirit or essential characteristics. For example, while pressurized air will normally be used for fluidizing and conveying the particulate material, as well as the supplemental air supply, there may be instances in which other gases, such as nitrogen or other inert gases may be used. The described embodiments are thus to be considered in all respects only as illustrative and not restrictive, and the scope of the invention is, therefore, indicated by the appended claims rather than by the foregoing description. All changes which come within the meaning and range of equivalency of the claims are to be embraced within their scope.

We claim:

1. A dry particulate dispersion system comprising:
a) a fluidized bed of particulate material;
b) an intake device inside said fluidized bed through which said particulate material may be withdrawn from the fluidized bed; and
c) a controllable source of pressurized gas connected to and providing supplemental gas to the intake device, the amount of supplemental gas supplied to the intake device controlling the amount of particulate material withdrawn through said intake device.

2. The apparatus of claim 1 further comprising a venturi eductor connected to said intake device for withdrawing particulate material therethrough and entraining the particulate material in a flowing stream of gas.

3. The apparatus of claim 2 further comprising a spray nozzle connected to said venturi eductor for spraying said particulate material.

4. The apparatus of claim 1 wherein the intake device includes a plurality of fluidized particulate intake ports.

5. The apparatus of claim 4 wherein the intake device further includes an inlet port for the supplemental gas and a plurality of supplemental gas channels, one of said channels extending between the supplemental gas inlet port and each of said plurality of fluidized particulate intake ports.

6. The apparatus of claim 2 wherein the venturi eductor is connected to said intake device by a flexible suction hose.

7. The apparatus of claim 3 wherein the spray nozzle is connected to said venturi eductor by a conveying hose.

8. An apparatus for spraying a dry powder material onto a substrate comprising:
a) a fresh powder feeding system;
b) a fluidized bed receiving fresh powder from said powder feeding system and creating a fluidized bed of suspended powder;
c) an intake device in said fluidized bed;
d) a suction hose connected to said intake device for withdrawing suspended powder entering the intake device from the fluidized bed;
e) a source of supplemental air connected to said intake device and supplying a controllable flow of supplemental air to said intake device;
f) a venturi eductor connected to said suction hose and to a supply of pressurized air, the eductor including an orifice such that pressurized air flowing through the orifice creates a venturi that sucks suspended powder through the suction tube and entrains it in the air exiting out of the orifice; and
g) a spray nozzle connected to said venturi eductor, the spray nozzle being directed to spray said powdered material on said substrate.

9. The apparatus of claim 8 further comprising an enclosure where the powder is applied to the substrate and an excess powder recovery system connected to the enclosure.

10. The apparatus of claim 9 wherein the excess powder recovery system comprises a filter house.

11. A method of controlling the rate of particulate material addition to a flowing pressurized gas stream comprising the steps of:
a) providing a fluidized bed of suspended particulate material;
b) placing an intake device within the fluidized bed, the intake device having
i) at least one particulate material intake port,
ii) an outlet port, and
iii) a supplemental gas supply inlet port;
c) connecting the intake device outlet port to a conduit carrying the flowing pressurized gas stream;
d) causing a pressure differential between the at least one particulate intake port and the outlet port so that suspended particulate material in the fluidized bed enters the at least one intake port and passes out the outlet port and into said conduit; and
e) supplying supplemental gas to the intake device at a controlled rate, said controlled rate of supplemental gas affecting the rate of suspended particulate material entering the at least one particulate material intake port and hence the rate of addition of the particulate material to the flowing pressurized gas stream.

12. The method of claim 11 wherein the particulate material is baking soda.

13. The method of claim 11 wherein the flowing pressurized gas stream comprises pressurized air.

14. The method of claim 11 wherein the supplemental gas is air.

15. The method of claim 11 wherein the pressure differential is caused by applying suction to the intake device outlet port.

16. The method of claim 15 wherein the suction is created by a venturi eductor in said conduit.

17. The method of claim 11 wherein the supplemental gas is supplied at a controlled rate by controlling the pressure of the supplemental gas.

18. The method of claim 11 wherein the particulate material is added to the flowing pressurized gas stream at a rate of between about 50 and about 2500 g/min.

19. The method of claim 11 wherein the particulate material has a particle size of between about 5 microns and about 250 microns.

20. The method of claim 11 wherein the particulate material has a particle specific gravity of between about 0.85 g/cm³ and about 1.3 g/cm³.

21. The method of claim 11 wherein the rate of particulate matter addition can be controlled to within a range of 10 g/min. at a flow rate of about 500 g/min.
